(19) United States
(12) Patent Application Publication
(10) Pub. No.: US 2014/0272446 A1
(43) Pub. Date: Sep. 18, 2014

(54) WEAR-RESISTANT CLADDINGS

(71) Applicant: KENNAMETAL INC., Latrobe, PA (US)

(72) Inventors: Qingjun Zheng, Export, PA (US); Yixiong Liu, Greensburg, PA (US); Robert J. Vasinko, Latrobe, PA (US); Joel Thomas Dawson, North Huntingdon, PA (US); Michael J. Meyer, Irwin, PA (US)

(73) Assignee: Kannametal Inc., Latrobe, PA (US)

(21) Appl. No.: 13/834,682

(22) Filed: Mar. 15, 2013

(51) Int. Cl. B32B 15/04; B32B 3/26

(52) U.S. Cl. CPC B32B 15/043; B32B 3/266
USPC 428/545; 156/280; 156/245

(57) ABSTRACT

In one aspect, articles are described herein comprising wear-resistant claddings. An article described herein, in some embodiments, comprises a metallic substrate and a cladding adhered to the substrate, the cladding including a metal matrix composite layer comprising at least one hard particle tile having a pore structure infiltrated with matrix metal or matrix alloy. Infiltration of the pore structure of the hard particle tile by the matrix metal or alloy can render the tile fully dense or substantially fully dense.

### FIELD

The present invention relates to claddings for metal and alloy substrates and, in particular, to claddings having enhanced wear and/or erosion resistance and methods of making the same.

### BACKGROUND

Claddings are often applied to articles or components subjected to harsh environments or operating conditions in efforts to extend the useful lifetime of the articles or components. Various cladding identities and constructions are available depending on the mode of failure to be inhibited. For example, wear resistant, erosion resistant and corrosion resistant claddings have been developed for metal and alloy substrates. In the case of wear resistant and/or erosion resistant claddings, a construction of discrete hard particles dispersed in a metal or alloy matrix is often adopted. While effective in inhibiting wear and erosion in a wide variety of applications, claddings based on this construction have increasingly reached maximum wear and erosion resistance, thereby calling for the development of new cladding architectures.

### SUMMARY

In one aspect, articles are described herein comprising wear-resistant claddings which, in some embodiments, can demonstrate desirable abrasion and/or erosion resistance. An article described herein, in some embodiments, comprises a metallic substrate and a cladding adhered to the substrate, the cladding including a metal matrix composite layer comprising at least one hard particle tile having a pore structure infiltrated with matrix metal or matrix alloy. Infiltration of the pore structure of the hard particle tile by matrix metal or alloy can render the tile fully dense or substantially fully dense. In some embodiments, the metal matrix composite layer comprises a plurality of hard particle tiles having a pore structure infiltrated with matrix metal or alloy rendering the composite layer fully dense or substantially fully dense.

A metal matrix composite layer of a cladding described herein can also incorporate hard particles in the matrix metal or alloy that are unassociated with the hard particle tile(s). In some embodiments, for example, discrete hard particles surround one or more hard particle tiles infiltrated with matrix metal or alloy. Discrete hard particles can reside in spacing between adjacent hard particle tiles and/or reside between the metallic substrate and the hard particle tiles. Metal matrix composite incorporating hard particles unassociated with hard particle tiles can be fully dense or substantially fully dense.

Further, in some embodiments, a cladding described herein also comprises an intermediate layer between the metal matrix composite layer and the metallic substrate. The intermediate layer can comprise a layer of metal or alloy. Additionally, the intermediate layer can comprise matrix metal or alloy incorporating hard particles. Hard particles of an intermediate layer can have the same or different identity, size and/or structure as hard particles of the metal matrix composite layer overlying the intermediate layer.

In another aspect, methods of making cladded articles are described herein. A method of making a cladded article, in some embodiments, comprises providing a metallic substrate and positioning at least one hard particle tile having a pore structure over the substrate. Matrix metal or alloy is positioned adjacent to the porous hard particle tile and heated to infiltrate the pore structure of the tile providing a metal matrix composite cladding metallurgically bonded to the substrate. In being positioned adjacent to the porous hard particle tile prior to heating, matrix metal or alloy can be above, underneath and/or lateral to the porous hard particle tile. In some embodiments, a plurality of hard particle tiles having a pore structure are positioned over the substrate surface and infiltrated with matrix metal or alloy to provide a composite cladding metallurgically bonded to the metallic substrate. Pore structure infiltration by matrix metal or alloy can render the hard particle tiles fully dense or substantially fully dense.

Further, hard particles unassociated with hard particle tiles can also be incorporated in matrix metal or alloy of the composite cladding. Such unassociated hard particles, for example, can fill spacing between hard particle tiles and/or reside between hard particle tiles and the metallic substrate. When heated, matrix metal or alloy infiltrates the pore structure of the tiles and also flows over and between the unassociated hard particles providing the composite cladding metallurgically bonded to the substrate.

A method of making a cladded article may also employ a mold surrounding the metallic substrate surface to be cladded, resulting in a spacing between the mold and the substrate surface. One or more hard particle tiles having a pore structure can be affixed to the metallic substrate surface, affixed to surface of the mold or positioned in the spacing between the mold and the substrate surface. Matrix metal or alloy is positioned to infiltrate the pore structure the hard particle tile(s) when heated providing a cladding metallurgically bonded to the substrate. Infiltration of the pore structure of the hard particle tiles by matrix metal or alloy can render the tiles fully dense or substantially fully dense.

Additionally, hard particles unassociated with the hard particle tiles can be filled into the spacing between the mold and metallic substrate surface. Such hard particles, for example, can flow into spaces between hard particle tiles and/or spaces between hard particle tiles and the metallic substrate and mold. When heated, matrix metal or alloy infiltrates the pore structure of the hard particle tiles and also spacing among the hard particles unassociated with the tiles providing a cladding metallurgically bonded to the metallic substrate.

In another aspect, a method of making a cladded article comprises providing a substrate, providing an intermediate layer over the substrate and positioning at least one hard particle tile having a pore structure over the intermediate layer. Matrix metal or alloy is positioned adjacent to the porous hard particle tile and heated to infiltrate the pore structure of the tile providing a metal matrix composite layer over the intermediate layer. In some embodiments, a plurality of hard particle tiles having a porous structure are positioned over the intermediate layer and infiltrated with matrix metal or alloy rendering the tiles fully dense or substantially fully dense. As described herein, hard particles unassociated with the hard particle tiles can also be incorporated in the metal matrix composite layer, such as between hard particle tiles and/or between the intermediate layer and the hard particle tiles.

In some embodiments, an intermediate layer is formed prior to the overlying metal matrix composite layer. Alternatively, an intermediate layer may be formed during fabrication of the metal matrix composite layer. Further, a mold may be used for construction of a cladding comprising the metal matrix composite layer over the intermediate layer. As described herein, a mold can surround the metallic substrate surface to be cladded resulting in spacing between the mold and the substrate surface. A mold can be employed after formation of the intermediate layer or prior to formation of the intermediate layer.

These and other embodiments are described in greater detail in the detailed description which follows.

### BRIEF DESCRIPTION OF THE DRAWINGS

FIG. 1 is a scanning electron microscopy (SEM) image of a hard particle tile having pore structure according to one embodiment described herein.

FIG. 2 is an SEM image of a hard particle tile wherein the pore structure of the tile is infiltrated with matrix alloy according to one embodiment described herein.

FIG. 3 is a cross-sectional SEM image of a cladded substrate according to one embodiment described herein.

FIG. 4 is a cross-sectional SEM image of a cladded substrate according to one embodiment described herein.

FIG. 5 illustrates a mold having porous hard particle tiles affixed thereto according to one embodiment of a method of cladding an article described herein.

FIG. 6 illustrates use of a mold in cladding the outer diameter surface of a metallic substrate according to one embodiment described herein.

FIG. 7 illustrates use of a mold in cladding the outer diameter surface of a metallic substrate according to one embodiment described herein.

### DETAILED DESCRIPTION

Embodiments described herein can be understood more readily by reference to the following detailed description and examples and their previous and following descriptions. Elements, apparatus and methods described herein, however, are not limited to the specific embodiments presented in the detailed description and examples. It should be recognized that these embodiments are merely illustrative of the principles of the present invention. Numerous modifications and adaptations will be readily apparent to those of skill in the art without departing from the spirit and scope of the invention.

### I. Articles Comprising Wear-Resistant Cladding

In one aspect, articles are described herein comprising wear-resistant claddings which, in some embodiments, demonstrate desirable abrasion and/or erosion resistance. An article described herein, in some embodiments, comprises a metallic substrate and a cladding adhered to the substrate, the cladding including a metal matrix composite layer comprising at least one hard particle tile having a pore structure infiltrated with matrix metal or matrix alloy. Infiltration of the pore structure of the hard particle tile by the matrix metal or alloy can render the tile fully dense or substantially fully dense. In some embodiments, the metal matrix composite layer comprises a plurality of hard particle tiles having a pore structure infiltrated with matrix metal or alloy rendering the composite layer fully dense or substantially fully dense. A metal matrix composite layer described herein can also incorporate hard particles in the matrix metal or alloy that are unassociated with the hard particle tile(s).

Further, in some embodiments, a cladding described herein also comprises an intermediate layer between the metal matrix composite layer and the metallic substrate. The intermediate layer can comprise a layer of metal or alloy. Additionally, the intermediate layer can comprise matrix metal or alloy incorporating hard particles. Hard particles of an intermediate layer can have the same or different identity, size and/or structure as hard particles of the metal matrix composite layer overlying the intermediate layer.

Turning to specific components, articles described herein comprise metallic substrates. Suitable metallic substrates include metal or alloy substrates. A metallic substrate, for example, can be an iron-based alloy, nickel-based alloy, cobalt-based alloy, copper-based alloy or other alloy. In some embodiments, nickel alloy substrates are commercially available under the INCONEL®, HASTELLOY® and/or BALCO® trade designations. Cobalt alloy substrates, in some embodiments, are commercially available under the trade designation STELLITE®, TRIBALOY® and/or MEGALLIUM®. In some embodiments, substrates comprise cast iron, low-carbon steels, alloy steels, tool steels or stainless steels. A substrate can also comprise a refractory alloy material, such as tungsten-based alloys, molybdenum-based alloys or chromium-based alloys.

Moreover, substrates can have various geometries. In some embodiments, a substrate has a cylindrical geometry, wherein the inner diameter (ID) surface, outer diameter (OD) surface or both are coated with a cladding described herein. In some embodiments, for example, substrates comprise wear pads, pelletizing dies, radial bearings, extruder barrels, extruder screws, flow control components, roller cone bits, fixed cutter bits, piping or tubes. The foregoing substrates can be used in oil well and/or gas drilling applications, petrochemical applications, power generation, food and pet food industrial applications as well as general engineering applications involving abrasion, erosion and/or other types of wear.

As described herein, a cladding is adhered to the substrate, the cladding including a metal matrix composite layer comprising at least one hard particle tile having a pore structure infiltrated with matrix metal or matrix alloy. Infiltration of the hard particle tile pore structure by matrix metal or alloy can render the tile fully dense or substantially fully dense. Alternatively, the hard particle tile is not fully dense demonstrating some pore structure not fully infiltrated or occluded by the matrix metal or alloy.

Hard particle tiles having pore structure infiltrated with matrix metal or alloy can be formed of particle metal carbides, metal nitrides, metal carbonitrides, metal borides, metal silicides, cemented carbides, cast carbides, other ceramics or mixtures thereof. In some embodiments, metallic elements of hard particles of the porous tile comprise aluminum, boron, silicon and/or one or more metallic elements selected from Groups IVB, VB, and VIB of the Periodic Table according to the CAS designation.

In some embodiments, for example, hard particle tiles having pore structure infiltrated with matrix metal or alloy comprise carbides of tungsten, titanium, chromium, molybdenum, zirconium, hafnium, tantalum, niobium, rhenium, vanadium, boron or silicon or mixtures thereof. Hard particle tiles having pore structure, in some embodiments, comprise nitrides of aluminum, boron, silicon, titanium, zirconium, hafnium, tantalum or niobium, including cubic boron nitride, or mixtures thereof. Additionally, hard particle tiles can comprise borides such as titanium di-boride, B₄C or tantalum borides or silicides such as MoSi₂ or Al₂O₃—SiN. Hard particle tiles, in some embodiments, comprise crushed cemented carbide, crushed carbide, crushed nitride, crushed boride, crushed silicide, ceramic particle reinforced metal matrix, silicon carbide metal matrix composites or combinations thereof. Crushed cemented carbide particles, for example, can have less than 20 weight percent metallic binder. Additionally, hard particle tiles having pore structure can comprise intermetallic compounds such as nickel aluminide and molybdenum silicide.

Hard particle tiles can have any grain or particle size not inconsistent with the objectives of the present invention. The hard particle tiles, in some embodiments, have a particle size distribution ranging from about 10 nm to about 1 mm. Hard particle tiles can also demonstrate bimodal or multi-modal particle size distributions.

Hard particles tiles can also demonstrate any desired particle or grain geometry. Particles or grains of the hard particles tiles can have a spherical, elliptical and/or polygonal geometry. Particles or grains of a tile can also have irregular shapes, including shapes with sharp edges.

As described further herein, hard particles can be partially sintered or otherwise densified to provide a hard particle tile having a pore structure. In having a pore structure, a hard particle tile demonstrates porosity. Porosity of a hard particle tile, in some embodiments, has a value provided in Table I.

TABLE I
Porosity of the Hard Particle Tile
Hard Particle Tile Porosity - Volume %
10-50
15-40
20-35

In having a pore structure and accompanying porosity, hard particle tiles of claddings described herein are differentiated from cladding ceramic or cermet tiles that are fully dense, demonstrating no porosity prior to incorporation in claddings of the prior art.

Porosity of hard particle tiles described herein, in some embodiments, is interconnected porosity. Interconnected porosity can comprise interconnected pore structures permitting matrix metal or alloy to penetrate and flow throughout the body of a hard particle tile, thereby providing a greater degree of bonding between the matrix metal or alloy and the hard particle tile. As described herein, infiltration of the matrix metal or alloy into porosity of a hard particle tile can render the hard particle tile fully dense or substantially fully dense. FIG. 1 is an SEM image of a hard particle tile having pore structure according to one embodiment described herein. As provided in FIG. 1, the hard particle tile demonstrates pore structure throughout the tile permitting matrix metal or alloy to penetrate and flow throughout the bulk of the tile body. Further, FIG. 2 illustrates an SEM image of a hard particle tile wherein the pore structure of the tile is infiltrated with matrix metal or matrix alloy according to one embodiment described herein. As evident in FIG. 2, the pore structure of the hard particle tile is infiltrated with matrix alloy, thereby rendering the tile fully dense or substantially fully dense.

Hard particle tiles of claddings described herein can be provided in any desired shape. Hard particle tiles having a pore structure can be polygonal, circular or elliptical. For example, in some embodiments, a hard particle tile is square, rectangular, hexagonal or round. Moreover, a hard particle tile can have a shape complimentary to one or more surfaces or geometries of the metallic substrate to which the cladding is applied. A hard particle tile, for example, can have a curvature complimentary to a surface curvature of the metallic substrate. In one embodiment, a hard particle tile has a curvature complimentary to piping, container(s), extruder barrels, extruder screws or bearings.

Hard particle tiles of claddings described herein can have any desired dimension(s). Dimensions of a hard particle tile can be selected according to several considerations including, but not limited to, the surface area and contour of the substrate to be cladded, the number of hard particle tiles contemplated for the cladding, the desired wear and/or erosion properties of the cladding, contour of the cladding and service environment. A hard particle tile, in some embodiments, has a thickness of at least about 500 μm.

A hard particle tile having a pore structure described herein can be provided by a variety of methods. A hard particle tile can be provided by forming hard particle powder into the desired shape of the tile, wherein the forming process provides the tile sufficient strength for handling and a pore structure/porosity described herein. In some embodiments, for example, hard particles are pressed into the desired shape with the aid of an organic binder and partially sintered. Alternatively, hard particles can be provided in a mold of the desired shape and partially sintered. In some embodiments, hard particle powder can be combined with organic binder to provide a flexible sheet, and subsequently partially sintered to provide a porous hard particle tile. Additional methods of providing hard particle tiles having a pore structure described herein include hard particle powder consolidation into the desired shape by extrusion, tape casting, slip casting, injection molding or spray forming followed by partial sintering.

Partial sintering conditions for hard particle tiles in green form are selected according to several factors including hard particle identity and desired pore structure and/or porosity of the tile. In some embodiments wherein hard particles comprising metal binder are used, such as crushed cemented carbides, lower temperatures can be employed during partial sintering to prevent metal binder of the particles from reducing porosity of the resulting hard particle tile. Partial sintering of hard particle tiles can be administered by conventional vacuum sintering, pressurized sintering, microwave sintering, induction sintering or hot pressing techniques.

Alternatively, a hard particle tile described herein having sufficient strength for handling is not partially sintered prior to arrangement over a metallic substrate for subsequent infiltration by matrix metal or alloy in the formation of a metal matrix composite layer. Instead, the hard particle tile is provided over the substrate in green form, and partially sintered at a temperature, pressure and time period insufficient to flow matrix metal or alloy but sufficient to densify the hard particle tile to the desired level. Binders or other organic materials of the green tile are decomposed or burned off during this partial sintering process. Matrix metal or alloy over or adjacent to the tile is subsequently melted at a higher temperature to infiltrate the pore structure of the hard particle tile, rendering the hard particle tile fully dense or substantially fully dense.

A metal matrix composite layer of a cladding can comprise a single hard particle tile having a pore structure infiltrated with matrix metal or alloy. For example, a single hard particle tile can be commensurate with the entire OD or ID surface of a cylindrical substrate to be cladded. In such embodiments, the hard particle tile is continuous in nature.

Further, a metal matrix composite layer of a cladding can comprise a plurality of hard particle tiles having a pore structure infiltrated with matrix metal or alloy rendering the tiles fully dense or substantially fully dense. Hard particle tiles can be arranged in a pattern over a surface of the substrate. A pattern of the hard particle tiles can be predetermined according to several considerations, including the surface area and geometry of the substrate to be cladded, desired wear and/or erosion characteristics of the cladding and the service environment.

As described herein, spacing between hard particle tiles can be filled with hard particles unassociated with the tiles. When heated, matrix metal or alloy infiltrates the hard particle tiles and also flows over and between the unassociated hard particles providing a fully dense or substantially fully dense metal matrix composite layer of the cladding. Moreover, in some embodiments, matrix metal or alloy is operable to fill spacing between hard particle tiles not occupied by unassociated hard particles as well as infiltrate pore structure of the hard particle tiles to provide a fully dense or substantially fully dense metal matrix composite layer. Spacing between hard particle tiles, in some embodiments, can range from less than 100 μm to greater than 5 mm.

In some embodiments, unassociated hard particles can also reside between the metallic substrate surface and the hard particle tile(s), wherein matrix metal or alloy infiltrates the pore structure of the hard particle tiles and flows over and between the unassociated hard particles to provide a metal matrix composite cladding layer metallurgically bonded to the metallic substrate. Further, in some embodiments, unassociated hard particles do not reside between the metallic substrate and the hard particle tiles. In such embodiments, the hard particles tiles can be infiltrated with matrix metal or alloy and directly bonded to the metallic substrate by the matrix metal or alloy.

Hard particles unassociated with hard particle tile(s) in metal matrix composite of a cladding described herein can comprise particles of metal carbides, metal nitrides, metal carbonitrides, metal borides, metal silicides, cemented carbides, cast carbides or other ceramics or mixtures thereof. In some embodiments, metallic elements of such hard particles comprise aluminum, silicon, boron and/or one or more metallic elements selected from Groups IVB, VB, and VIB of the Periodic Table. Hard particles, in some embodiments, comprise tungsten carbide, boron nitride or titanium nitride or mixtures thereof.

In some embodiments, for example, unassociated hard particles of a metal matrix composite layer comprise carbides of tungsten, titanium, chromium, molybdenum, zirconium, hafnium, tantalum, niobium, rhenium, vanadium, iron, boron or silicon or mixtures thereof. The hard particles, in some embodiments, comprise nitrides of aluminum, boron, silicon, titanium, zirconium, hafnium, tantalum or niobium, including cubic boron nitride, or mixtures thereof. Additionally, in some embodiments, the hard particles comprise borides such as titanium di-boride, B₄C or tantalum borides or silicides such as MoSi₂ or Al₂O₃—SiN. Unassociated hard particles of a metal matrix composite layer can comprise crushed cemented carbide, crushed carbide, crushed nitride, crushed boride or crushed silicide or combinations thereof. In some embodiments, the hard particles comprise intermetallic compounds such as nickel aluminide and molybdenum silicide.

Additionally, hard particles of a metal matrix composite layer unassociated with a hard particle tile can comprise metallic particles having higher melting points than the matrix metal or alloy. In some embodiments, for example, metallic particles include those of molybdenum, chromium, tungsten and/or alloys thereof. Unassociated hard particles can be the same or different from hard particles of the tile(s).

Hard particles of a metal matrix composite layer unassociated with a hard particle tile can have any size not inconsistent with the objectives of the present invention. In some embodiments, such hard particles have a size distribution ranging from about 0.1 μm to about 5 mm. Further the hard particles can demonstrate bimodal or multi-modal size distributions.

Unassociated hard particles can have any desired shape or geometry. In some embodiments, such hard particles have a spherical, elliptical or polygonal geometry. Additionally, the hard particles can have irregular shapes, including shapes with sharp edges.

Metal matrix composite layers of claddings described herein can comprise a hard particle content having a value selected from Table II. The hard particle content of the metal matrix composite is the sum of hard particles contained in one or more hard particle tiles and hard particles of the composite unassociated with the hard particle tile(s).

TABLE II
Hard Particle Content of Composite Layer (Volume %)
Hard Particle Content - Vol. %
50≦
60≦
70≦
80≦
50-95
65-90

Further, matrix metal or alloy of a composite layer of the cladding can be selected according to several considerations including, but not limited to, the compositional identity of the hard particle tile(s), the compositional identity of the metallic substrate and/or the service environment. For example, matrix metal or alloy has melting point or solidus temperature lower than particles of the hard particle tiles or an intermediate layer of the cladding discussed further herein.

In some embodiments, matrix metal or alloy of the composite layer is a brazing metal or brazing alloy. Any brazing metal or alloy not inconsistent with the objectives of the present invention can be used as the matrix metal or alloy infiltrating the pore structure/porosity of the hard particle tiles. For example, matrix alloy can comprise a nickel-based alloy having compositional parameters derived from Table III:

TABLE III
Ni-Based Matrix Alloy Compositional Parameters

| Element | Amount (wt. %) |
|---|---|
| Chromium | 0-30 |
| Molybdenum | 0-5 |
| Niobium | 0-5 |
| Tantalum | 0-5 |
| Tungsten | 0-20 |
| Iron | 0-6 |
| Carbon | 0-5 |
| Silicon | 0-15 |
| Phosphorus | 0-10 |
| Aluminum | 0-1 |
| Copper | 0-50 |
| Boron | 0-5 |
| Nickel | Balance |

In some embodiments, the matrix alloy of the composite layer is selected from the Ni-based alloys of Table IV.

TABLE IV
Ni-Based Matrix Alloy Compositional Parameters

| Ni-Based | |
|---|---|
| Alloy | Compositional Parameters (wt. %) |
| 1 | Ni—(13.5-16)% Cr—(2-5)% B—(0-0.1)% C |
| 2 | Ni—(13-15)% Cr—(3-6)% Si—(3-6)% Fe—(2-4)% B—C |
| 3 | Ni—(3-6)% Si—(2-5)% B—C |
| 4 | Ni—(13-15)% Cr—(9-11)% P—C |
| 5 | Ni—(23-27)% Cr—(9-11)% P |
| 6 | Ni—(17-21)% Cr—(9-11)% Si—C |
| 7 | Ni—(20-24)% Cr—(5-7.5)% Si—(3-6)% P |
| 8 | Ni—(13-17)% Cr—(6-10)% Si |
| 9 | Ni—(15-19)% Cr—(7-11)% Si—)0.05-0.2)% B |
| 10 | Ni—(5-9)% Cr—(4-6)% P—(46-54)% Cu |
| 11 | Ni—(4-6)% Cr—(62-68)% Cu—(2.5-4.5)% P |
| 12 | Ni—(13-15)% Cr—(2.75-3.5)% B—(4.5-5.0)% |
| | Si—(4.5-5.0)% Fe—(0.6-0.9)% C |
| 13 | Ni—(18.6-19.5)% Cr—(9.7-10.5)% Si |
| 14 | Ni—(8-10)% Cr—(1.5-2.5)% B—(3-4)% Si—(2-3)% Fe |
| 15 | Ni—(5.5-8.5)% Cr—(2.5-3.5)% B—(4-5)% Si—(2.5-4)% Fe |

Matrix alloy of a composite layer, in some embodiments, is a copper-based alloy. Suitable copper-based alloys can comprise additive elements of 0-50 wt. % nickel, 0-30 wt. % manganese, 0-45 wt. % zinc, 0-10 wt. % aluminum, 0-5 wt. % silicon, 0-5 wt. % iron as well as other elements including phosphorous, chromium, beryllium, titanium, boron, tin, lead, indium, antimony and/or bismuth. In some embodiments, alloy matrix of the composite layer is selected from the Cu-based alloys of Table V.

TABLE V
Cu-Based Matrix Alloy Compositional Parameters

| Cu-Based | |
|---|---|
| Alloy | Compositional Parameters (wt. %) |
| 1 | Cu—(18-27)% Ni—(18-27)% Mn |
| 2 | Cu—(8-12)% Ni |
| 3 | Cu—(29-32)% Ni—(1.7-2.3)% Fe—(1.5-2.5)% Mn |
| 4 | Cu—(2.8-4.0)% Si—1.5% Mn—1.0% Zn—1.0% |
| | Sn—Fe—Pb |
| 5 | Cu—(7.0-8.5)Al—(11-14)% Mn—2-4)% Fe—(1.5-3.0)% Ni |
| 6 | Cu—(14-18)% Mn—(6-10)% Ni—(24-28)% Zn |
| 7 | Cu—(41-45)% Zn |
| 8 | Cu—(8-12)% Ni—(39-43)% Zn |
| 9 | Cu—(13-17)% Ni—(18-22)% Zn |
| 10 | Cu—(13-17)% Ni—(6-10)% Zn—(22-26)% Mn |

Matrix alloy of a composite layer, in some embodiments, is cobalt-based alloy. Suitable cobalt-based alloys can comprise additive elements of chromium, nickel, boron, silicon, tungsten, carbon, phosphorous as well as other elements. In one embodiment, for example, a cobalt-based matrix alloy has the compositional parameters of Co-(15-19) % Ni-(17-21) % Cr-(2-6) % W-(6-10) % Si-(0.5-1.2) % B-(0.2-0.6) % C. In other embodiments, for example, a cobalt-based matrix alloy comprises 5-20 wt. % chromium, 0-2 wt. % tungsten, 10-35 wt. % molybdenum, 0-20 wt. % nickel, 0-5 wt. % iron, 0-2 wt. % manganese, 0-5 wt. % silicon, 0-5 wt. % vanadium, 0-0.3 wt. % carbon, 0-5 wt. % boron and the balance cobalt.

Matrix alloy of a composite layer can also be iron-based alloy. In some embodiments, matrix alloy is an iron-based alloy selected from Table VI.

TABLE VI
Fe-Based Matrix Alloy Compositional Parameters

| Fe-Based Alloy | Compositional Parameters (wt. %) |
|---|---|
| 1 | Fe—(2-6)% C |
| 2 | Fe—(2-6)% C—(0-5)% Cr—(28-37)% Mn |
| 3 | Fe—(2-6)% C—(0.1-5)% Cr |
| 4 | Fe—(2-6)% C—(0-37)% Mn—(8-16)% Mo |

Matrix metal or alloy can be present in a composite layer of a cladding described herein in an amount up to about 50 volume percent. Matrix metal or alloy, in some embodiments, is present in a composite layer in an amount selected from Table VII.

TABLE VII
Volume Percent of Metal or Alloy Matrix in Cladding
Metal or Alloy Matrix - Vol. %
≦50
≦40
≦35
≦30
≦25
≦20
5-50
10-40

A metal matrix composite layer having a construction described herein, in some embodiments, displays an average volume loss (AVL) less than 12.0 mm³ according to ASTM G65 Standard Test Method for Measuring Abrasion Using the Dry Sand/Rubber Wheel, Procedure A. In some embodiments, a metal matrix composite layer displays an AVL according to Table VIII.

TABLE VIII
AVL of Metal Matrix Composite Layer
AVL of Freestanding Composite Article* (mm³)

≦12
≦10
≦8
≦5
≦4
3-12
2-6
*ASTM G65 Standard Test Method for Measuring Abrasion Using the Dry Sand/Rubber Wheel, Procedure A

A metal matrix composite layer having a construction described herein, in some embodiments, demonstrates an erosion rate of less than 0.03 mm³/g at a particle impingement angle of 90° according to ASTM G76-07—Standard Test Method for Conducting Erosion Tests by Solid Particle Impingement Using Gas Jets. A metal matrix composite layer, in some embodiments, displays an erosion rate less than 0.02 mm³/g at a particle impingement angle of 90° according to ASTM G76-07. Further, a metal matrix composite layer, in some embodiments, displays an erosion rate less than 0.015 mm³/g at a particle impingement angle of 90° according to ASTM G76-07.

A metal matrix composite layer having a construction described herein can be in direct contact with the metallic substrate and metallurgically bonded to the metallic substrate through interaction of the matrix metal or alloy with substrate. In some embodiments, for example, matrix metal or alloy of the composite layer diffuses into a surface region of the metallic substrate establishing an interfacial transition region. The interfacial transition region can have a structure different from the matrix metal or alloy and different from the metal or alloy substrate.

Alternatively, a cladding described herein further comprises one or more intermediate layers between the metal matrix composite layer and the metallic substrate. An intermediate layer, in some embodiments, comprises a layer of metal or alloy. Suitable metals or alloys for an intermediate layer can be selected according to various considerations including, but not limited to, the compositional identity of the substrate, desired hardness of the intermediate layer, compositional identity of the matrix metal or alloy of the composite layer and/or the desired functionality of the intermediate layer. In some embodiments, for example, an intermediate layer can demonstrate crack arrest, stress arrest, bonding enhancement and/or corrosion resistant functionalities.

An intermediate layer, in some embodiments, is nickel or nickel-based alloy. Nickel-based alloys for use as an intermediate layer can contain additive elements of varying contents. Additive elements can include boron, aluminum, carbon, silicon, phosphorous, titanium, zirconium, yttrium, rare earth elements, vanadium, niobium, tantalum, chromium, molybdenum, tungsten, manganese, iron, cobalt, copper or silver or combinations thereof. In some embodiments, nickel-based alloys suitable for an intermediate layer have compositional parameters derived from Table IX:

TABLE IX
Ni-Based Alloy Composition of Intermediate Layer

| Element | Amount (wt. %) |
|---|---|
| Chromium | 0-30 |
| Molybdenum | 0-28 |
| Niobium | 0-6 |
| Tantalum | 0-6 |
| Cobalt | 0-15 |
| Tungsten | 0-15 |
| Iron | 0-50 |
| Carbon | 0-5 |
| Manganese | 0-2 |
| Silicon | 0-5 |
| Titanium | 0-2 |
| Aluminum | 0-1 |
| Copper | 0-50 |
| Boron | 0-5 |
| Nickel | Balance |

In some embodiments, for example, nickel-based alloy of an intermediate layer comprises 18-23 wt. % chromium, 5-11 wt. % molybdenum, 2-5 wt. % total of niobium and tantalum, 0-5 wt. % iron, 0-5 wt. % boron and the balance nickel. Nickel-based alloy of an intermediate layer can comprise 12-20 wt. % chromium, 5-11 wt. % iron, 0.5-2 wt. % manganese, 0-2 wt. % silicon, 0-1 wt. % copper, 0-2 wt. % carbon, 0-5 wt. % boron and the balance nickel. Nickel-based alloy of an intermediate layer, in some embodiments, comprises 3-27 wt. % chromium, 0-10 wt. % silicon, 0-10 wt. % phosphorus, 0-10 wt % iron, 0-2 wt. % carbon, 0-5 wt % boron and the balance nickel.

Further, in some embodiments, nickel-based alloy of an intermediate layer is nickel-iron alloy such as Ni-30Fe or nickel-chromium alloy, such as Ni-20Cr or Ni-10Cr. Additionally, nickel-based alloy includes nickel-copper alloy, such as Ni-55Cu or Ni-30Cu. In some embodiments, a nickel-based alloy is Ni-2Mn-2Al-1Si. Nickel-based alloys of an intermediate layer are commercially available under the HASTELLOY®, INCONEL® and/or BALCO® trade designations.

An alloy of an intermediate layer, in some embodiments, is copper-based alloy or chromium-based alloy. Additive elements for copper-based alloys can include beryllium, aluminum, nickel, chromium, cobalt, manganese, iron, silicon, zinc, zirconium, lead, tungsten, titanium, tantalum, niobium, boron or phosphorous or combinations thereof. In some embodiments, copper-based alloy of an intermediate layer is Cu-45Ni, Cu-10Ni, Cu-(18-27)Ni-(18-27)Mn or Cu-(29-32)Ni-(1.7-2.3)Fe-(1.5-2.5)Mn. An intermediate layer can also be formed of cobalt or a cobalt-based alloy.

Additive elements for cobalt-based alloys can comprise chromium, molybdenum, tungsten, nickel, iron, boron, carbon, nitrogen, phosphorous, aluminum, silicon, manganese, titanium, vanadium, niobium, tantalum, zirconium, yttrium or copper or combinations thereof. Cobalt alloy of an intermediate layer can have compositional parameters selected from Table X.

TABLE X
Co-Based Alloy Composition of Intermediate Layer

| Element | Amount (wt. %) |
|---|---|
| Chromium | 5-35 |
| Tungsten | 0-35 |
| Molybdenum | 0-35 |
| Nickel | 0-20 |
| Iron | 0-25 |
| Manganese | 0-2 |
| Silicon | 0-5 |
| Vanadium | 0-5 |
| Carbon | 0-4 |
| Boron | 0-5 |
| Cobalt | Balance |

In some embodiments, for example, cobalt-based alloy of an intermediate layer is selected from Table XI.

TABLE XI
Co-Based Alloy of Intermediate Layer

| Co-Based | |
|---|---|
| Alloy | |
| Cladding | Compositional Parameters (wt. %) |
| 1 | Co—(15-35)% Cr—(0-35)% W—(0-20)% Mo—(0-20)% |
| | Ni—(0-25)% Fe—(0-2)% Mn—(0-5)% Si—(0-5)% |
| | V—(0-4)% C—(0-5)% B |
| 2 | Co—(20-35)% Cr—(0-10)% W—(0-10)% Mo—(0-2)% |
| | Ni—(0-2)% Fe—(0-2)% Mn—(0-5)% Si—(0-2)% |
| | V—(0-0.4)% C—(0-5)% B |
| 3 | Co—(5-20)% Cr—(0-2)% W—(10-35)% Mo—(0-20)% |
| | Ni—(0-5)% Fe—(0-2)% Mn—(0-5)% Si—(0-5)% |
| | V—(0-0.3)% C—(0-5)% B |
| 4 | Co—(15-35)% Cr—(0-35)% W—(0-20)% Mo—(0-20)% |
| | Ni—(0-25)% Fe—(0-1.5)% Mn—(0-2)% Si—(0-5)% |
| | V—(0-3.5)% C—(0-1)% B |
| 5 | Co—(20-35)% Cr—(0-10)% W—(0-10)% Mo—(0-1.5)% |
| | Ni—(0-1.5)% Fe—(0-1.5)% Mn—(0-1.5)% |
| | Si—(0-1)% V—(0-0.35)% C—(0-0.5)% B |
| 6 | Co—(5-20)% Cr—(0-1)% W—(10-35)% Mo—(0-20)% |
| | Ni—(0-5)% Fe—(0-1)% Mn—(0.5-5)% Si—(0-1)% |
| | V—(0-0.2)% C—(0-1)% B |

Cobalt alloys of an intermediate layer are commercially available under the trade designation STELLITE®, TRIBALOY® and/or MEGALLIUM®.

Moreover, in some embodiments, an intermediate layer is stainless steel. Stainless steels of an intermediate layer can include austenic stainless steels, including 300 series stainless steels (e.g. 304, 316, 317, 321, 347) and 600 series stainless steels (e.g., 630-635, 650-653, 660-665). In some embodiments, stainless steels of an intermediate layer comprise ferritic stainless steels, such as those containing 10-27% chromium with marginal nickel contents. Stainless steels of an intermediate layer can also comprise duplex stainless steels or specialty iron-based alloys, including Fe-24Ni-20.5Cr-6.2Mo and Fe—Ni(32.5-35)-Cr(19-21)-Cu(3-4)-Mo(2-3)-Mn(<2)-Si(<1).

Further, in some embodiments, an intermediate layer may contain matrix metal or alloy of the composite layer overlying the intermediate layer. In some embodiments, for example, a metal or alloy intermediate layer has a pore structure infiltrated with matrix metal or alloy of the overlying composite layer. Infiltration of a porous metal or alloy intermediate layer with matrix metal or alloy of the overlying composite layer can render the intermediate layer fully dense or substantially fully dense.

In some embodiments, an intermediate layer comprises hard particles disposed in the metal or alloy providing metal matrix composite. The matrix metal or alloy of the intermediate layer can be the same or different than matrix metal or alloy of the overlying composite layer. In some embodiments, for example, matrix metal or alloy of the composite layer infiltrates the intermediate layer providing a matrix for the particles of the intermediate layer.

Hard particles suitable for use in an intermediate layer can comprise metal carbides, metal nitrides, metal borides, metal silicides, ceramics, cemented carbides or cast carbides or mixtures thereof. Hard particles can also comprise precipitates in the matrix metal or alloy of the intermediate layer. Additionally, hard particles of an intermediate layer can comprise any of the hard particles described above for the metal matrix composite layer.

Hard particles can be present in matrix metal or alloy of an intermediate layer in any amount not inconsistent with the objectives of the present invention. In some embodiments, hard particles are present in the metal or alloy of an intermediate layer in an amount less than about 40 volume percent. In some embodiments, hard particles are present in the metal or alloy of an intermediate layer in an amount less than about 20 volume percent or less than about 10 volume percent.

FIG. 3 is a cross-sectional SEM image of a cladded substrate employing a metal matrix composite intermediate layer according to one embodiment described herein. As illustrated in FIG. 3, the cladding (31) is metallurgically bonded the metal substrate (32) and comprises a metal matrix composite intermediate layer (33) between the substrate (32) and the composite outer layer (34) of hard particle tiles infiltrated with matrix alloy. Additionally, FIG. 4 is a cross-sectional SEM image of a cladded substrate employing a metal matrix composite intermediate layer according to one embodiment described herein. Similar to FIG. 3, the cladding (41) of FIG. 4 is metallurgically bonded to the metal substrate (42) and comprises a metal matrix composite intermediate layer (43) between the substrate (42) and the composite outer layer (44) of hard particle tiles infiltrated with matrix alloy. The microstructural differences between infiltrated hard particle tiles of the cladding (41) and the metal matrix composite intermediate layer (43) are evident. The infiltrated hard particle tiles provide the outer layer (44) a substantially uniform microstructure in sharp contrast to the metal matrix composite intermediate layer (43) having discrete hard particles randomly dispersed in matrix alloy.

An intermediate layer having a construction described herein can have any thickness not inconsistent with the objectives of the present invention. In some embodiments, an intermediate layer has a thickness of at least about 100 μm. In some embodiments, an intermediate layer has a thickness ranging from about 200 μm to about 5 mm. An intermediate layer, in some embodiments, has a thickness ranging from about 500 μm to about 2 mm.

When present, an intermediate layer can be metallurgically bonded to the substrate and the metal matrix composite layer overlying the intermediate layer. Moreover, in some embodiments, an intermediate layer having a construction described herein has a hardness less than that of the metal matrix composite layer. An intermediate layer can have a hardness less than about 50 according to the Rockwell C scale (HRC). An intermediate layer can have a hardness less than about 40 HRC or less than about 30 HRC. HRC values recited herein are determined according to ASTM E18-08b Standard Test Method for Rockwell Hardness of Metallic Materials.

As described herein, an intermediate layer can be formed on the metallic substrate prior to the metal matrix composite layer and provides a substantially uniform finish in preparation of deposition of the metal matrix composite layer. In some embodiments, for example, an intermediate layer has a surface roughness (Ra_{μinches}) less than about 250 Ra prior to deposition of the metal matrix composite layer. In some embodiments, an intermediate layer has a surface roughness of less than about 200 Ra or less than about 100 Ra prior to deposition of the metal matrix composite layer. An intermediate layer, in some embodiments, has a surface roughness ranging from about 20 Ra to about 250 Ra or from about 30 Ra to about 125 Ra prior to deposition of the metal matrix composite layer.

An intermediate layer can be provided with desired surface roughness by mechanical means such as grinding, sand/grit blasting or combinations thereof. Surface roughness values recited herein are determined according to ASTM D7125-05 Standard Test Method for Measurement of Surface Roughness of Abrasive Blast Cleaned Metal Surfaces Using a Portable Stylus Instrument.

### II. Methods of Making Cladded Articles

In another aspect, methods of making cladded articles are described herein. A method of making a cladded article, in some embodiments, comprises providing a metallic substrate and positioning at least one hard particle tile having a pore structure over the substrate. Matrix metal or alloy is positioned adjacent to the porous hard particle tile and heated to infiltrate the pore structure of the tile providing a metal matrix composite cladding metallurgically bonded to the substrate. In being positioned adjacent to the porous hard particle tile prior to heating, matrix metal or alloy can be above, underneath or lateral to the porous hard particle tile. In some embodiments, a plurality of hard particle tiles having a pore structure are positioned over the substrate surface and infiltrated with matrix metal or alloy to provide a composite cladding metallurgically bonded to the metallic substrate. Pore structure infiltration by matrix metal or alloy can render the hard particle tiles fully dense or substantially fully dense.

Turning now to specific steps, methods described herein comprise providing a metallic substrate. Suitable metallic substrates can comprise any substrate described in Section I herein, including cast iron, low-carbon steels, alloy steels, tool steels, stainless steels, nickel metal, nickel alloys, copper alloys, cobalt metal or cobalt alloys. The substrate surface can be cleaned chemically and/or mechanically prior to application of the cladding. In one embodiment, for example, the substrate surface can be cleaned by grit blasting.

At least one hard particle tile having a pore structure is positioned over a surface of the substrate. For example, in one embodiment, a single porous hard particle tile commensurate with the surface area of the substrate to be cladded is positioned over the substrate. In such an embodiment, the hard particle tile is continuous over the substrate surface. Alternatively, a plurality of porous hard particle tiles are positioned over a surface of the substrate. As described herein, the hard particle tiles can be arranged in a predetermined pattern over the surface of the substrate. Suitable hard particle tiles for use in methods described herein can have any construction and/or properties described in Section I hereinabove. In some embodiments, for example, a hard particle tile comprises hard particles described in Section I and has porosity selected from Table I herein.

Matrix metal or alloy is positioned adjacent to the one or more hard particle tiles and heated to infiltrate the pore structure of the tiles with matrix metal or alloy providing a fully dense or substantially fully dense cladding metallurigically bonded to the metallic substrate. In being positioned adjacent to the one or more hard particle tiles prior to heating, matrix metal or alloy can be above, underneath and/or lateral to the hard particle tiles. Further, hard particles unassociated with the tiles can be positioned or dispersed in spacing between the hard particle tiles. Hard particles positioned between and unassociated with hard particle tiles can comprise any of the hard particles described in Section I herein. Spacing between hard particle tiles can be filled by flowing discrete hard particles into the spacing. Alternatively, spacing between hard particle tiles can be filled with a sheet comprising organic binder and hard particles such as a polymeric sheet described further herein. In addition to infiltrating the pore structure of hard particle tiles, matrix metal or alloy infiltrates spacing between the hard particle tiles flowing over and between discrete hard particles in the spacing.

In some embodiments, a layer of discrete hard particles is positioned over the metallic substrate and one or more hard particle tiles having a pore structure are positioned over this hard particle layer. The discrete hard particles can be carried by a flexible sheet comprising organic binder as described below to provide the hard particle layer. Matrix metal or alloy is then heated to infiltrate the hard particle layer and pore structure of the hard particle tiles rendering a multilayer cladding metallurgically bonded to the substrate. Prior to heating, the matrix metal or alloy may be positioned between the hard particle layer and the metallic substrate or between the hard particle layer and the hard particle tiles. Matrix metal or alloy, in some embodiments, is positioned over the hard particle tiles. Prior to heating, matrix metal or alloy can be provided as a sheet/foil or be carried in a flexible sheet of organic binder in powder form.

Matrix metal or alloy can comprise any metal or alloy described in Section I herein, including nickel-based alloys, copper-based alloys, cobalt-based alloys or iron-based alloys. Prior to heating, matrix metal or alloy can be a foil, a slab or blocks having compositional parameters selected from any of Tables III-VI herein. Moreover, prior to heating, matrix metal or alloy can also be provided in particulate form, chunks, blocks or mixtures thereof. Particulate forms of matrix metal or alloy can comprise particles of various sizes and shapes. In some embodiments, matrix metal or alloy is provided as pre-alloyed powder having compositional parameters derived from any of Tables III-VI herein.

When provided as a powder, matrix metal or alloy can be disposed in a carrier for positioning over, under or adjacent to one or more porous hard particle tiles. In some embodiments, for example, powder matrix metal or alloy is combined with organic binder in the formation of a flexible sheet. The flexible sheet comprising powder matrix metal or alloy can be cloth-like in nature. In some embodiments, organic binder of the sheet comprises one or more polymeric materials. Suitable polymeric materials for use in the sheet can include one or more fluoropolymers including, but not limited to, polytetrafluoroethylene (PTFE).

Any matrix metal or alloy recited in Section I in powder form can be combined or blended with an organic binder for the formation of the sheet. For example, pre-alloyed powder having compositional parameters selected from any of Tables III-VI herein can be combined with an organic material. The organic binder and the powder metal or alloy are mechanically worked or processed to trap the powder metal or alloy in the organic binder. In one embodiment, for example, powder matrix alloy is mixed with 3-15% PTFE by volume and mechanically worked to fibrillate the PTFE and trap the powder matrix alloy. Mechanical working can include rolling, ball milling, stretching, elongating, spreading or combinations thereof. In some embodiments, the sheet comprising powder matrix metal or alloy is subjected to cold isostatic pressing. The resulting sheet can have a low elastic modulus and high green strength. In some embodiments, a sheet comprising powder matrix metal or alloy is produced in accordance with the disclosure of one or more of U.S. Pat. Nos. 3,743,556, 3,864,124, 3,916,506, 4,194,040 and 5,352,526, each of which is incorporated herein by reference in its entirety.

Alternatively, powder matrix metal or alloy is combined with a liquid carrier for application over one or more porous hard particle tiles. In some embodiments, for example, powder matrix metal or alloy is disposed in a liquid carrier to provide a slurry or paint for application. Suitable liquid carriers for powder matrix metal or alloy comprise several components including dispersion agents, thickening agents, adhesion agents, surface tension reduction agents and/or foam reduction agents. In some embodiments, suitable liquid carriers are aqueous based.

Powder matrix metal or alloy disposed in a liquid carrier can be applied by several techniques including, but not limited to, spraying, brushing, flow coating, dipping and/or related techniques. The liquid composition can be applied in a single application or multiple applications. Moreover, in some embodiments, powder matrix metal or alloy disposed in liquid carriers can be prepared and applied to surfaces in accordance with the disclosure of U.S. Pat. No. 6,649,682 which is hereby incorporated by reference in its entirety.

As described above, after being positioned over, under or adjacent to one or more hard particle tiles or arranged on the surface of the metallic substrate, matrix metal or alloy is heated to infiltrate the pore structure/porosity of the hard particle tile(s) providing a composite cladding adhered to the substrate. The cladding can be fully dense and metallurgically bonded to the substrate. In embodiments wherein matrix metal or alloy is carried by a liquid or flexible sheet, organic components of the liquid or flexible sheet are decomposed or burned off during the heating process. Further, hard particles unassociated with hard particle tiles can also be incorporated in matrix metal or alloy of the composite cladding. Such unassociated hard particles, for example, can fill spacing between hard particle tiles and/or reside between hard particle tiles and the metallic substrate. When heated, matrix metal or alloy infiltrates the pore structure of the tiles and also flows over and between the unassociated hard particles providing the composite cladding metallurgically bonded to the substrate.

The substrate, hard particle tile(s), matrix metal or alloy and any unassociated hard particles are heated in vacuum, inert, reducing or ambient (air) atmosphere at a temperature and for a time period to allow the matrix metal or alloy to melt and infiltrate the pore structure of the hard particle tiles(s), flow over and between unassociated hard particles and fill spacing in the cladding. Flux can be used during heating processes enhancing flow of the molten matrix metal or alloy. In some embodiments, the hard particle tile(s) are rendered fully dense or substantially fully dense by infiltration of matrix metal or alloy into the pore structure or porosity of the tile(s). Further, flow and infiltration of the molten matrix metal or alloy can render the composite cladding fully dense or substantially fully dense and metallurgically bonded to the metallic substrate.

A method of making a cladded article may also employ a mold surrounding the metallic substrate surface to be cladded, forming a spacing between the mold and the substrate surface. One or more hard particle tiles having a pore structure can be affixed to the metallic substrate surface, affixed to a surface of the mold or positioned in the spacing between the mold and the substrate surface. Matrix metal or alloy is subsequently positioned to infiltrate the pore structure the hard particle tile(s) when heated providing a cladding metallurgically bonded to the substrate. Infiltration of the pore structure of the hard particle tiles by matrix metal or alloy can render the tiles fully dense or substantially fully dense.

Additionally, hard particles unassociated with the hard particle tiles can be filled into the spacing between the mold and metallic substrate surface. Such hard particles, for example, can flow into spaces between hard particle tiles and/or spaces between hard particle tiles and the metallic substrate and mold. When heated, matrix metal or alloy infiltrates the pore structure of the hard particle tiles and also flows over, under and/or between the hard particles unassociated with the tiles providing a cladding metallurgically bonded to the metallic substrate.

For example, a mold can be used for cladding the inner diameter of an extruder barrel or the inner diameter of a bearing. In such embodiments, hard particle tiles having pore structure can be affixed to the inner diameter surface of the metallic substrate or to the outer diameter surface of the mold. Alternatively, hard particle tiles having pore structure are positioned in the spacing between the substrate surface and mold after assembly of the substrate and mold. The porous hard particle tiles can be further arranged in any desired pattern. After the substrate and mold are assembled, matrix metal or alloy is placed in spacing between the metallic substrate surface and mold or in any manner facilitating infiltration of the porous hard particle tiles with the matrix metal or alloy under heating to provide a cladding metallurgically bonded to the substrate surface. Additionally, hard particles unassociated with the porous tiles may fill spacing among the mold, hard particle tiles and substrate prior to placement of matrix metal or alloy followed by infiltration of the matrix metal or alloy during heating. As described herein, unassociated hard particles can be carried in a sheet or liquid. In other embodiments, the unassociated hard particles are loose and poured into the substrate/mold assembly. Tapping or vibration can be applied to increase the packing density of the unassociated hard particles. Following heating and infiltration by the alloy matrix, the mold is removed to provide the cladded article. In some embodiments, the mold is re-usable after removal. In some embodiments, the mold is sacrificial being destroyed or rendered unsuitable for further use by removal.

The outer diameter of a substrate can be cladded in a similar manner, the principal difference being the mold is placed around the exterior surface of the substrate to be cladded. FIGS. 5-7 illustrate a method of cladding the outer diameter of a metallic substrate according to one embodiment described herein. As illustrated in FIG. 5, a mold (50) is provided and hard particle tiles (51) having pore structure are affixed to the inner diameter surface (52) of the mold (50). A metallic substrate (53), such as a bearing, is inserted into the mold (50) as shown in FIG. 6(a). The outer diameter surface (54) of the metallic substrate (53) faces the inner diameter surface (52) of the mold (50) and porous hard particle tiles (51). In FIG. 6(b), hard particles (55) unassociated with the porous hard particle tiles (51) are filled into spacing between the inner diameter surface (52) of the mold (50) and the outer diameter surface (54) of the metallic substrate (53). The unassociated hard particles (55) also fill the spacing between the porous hard particle tiles (51). Matrix metal or alloy (56) is then loaded.

As illustrated in FIG. 7(a), the matrix metal or alloy (56) is heated to infiltrate the pore structure of the hard particle tiles (51) and flow over and between the hard particles (55) unassociated with the tiles (51) to provide a fully dense or substantially fully dense cladding (57) metallurgically bonded to the outer diameter surface (54) of the metallic substrate (53). In FIG. 7(b), the mold (50) is removed to provide the cladded article.

A composite cladding made in accordance with a method described herein comprising one or more hard particle tiles having a pore structure infiltrated with matrix metal or alloy can have any of the properties described in Section I above for a cladding. For example, in some embodiments, the composite cladding exhibits an average volume loss (AVL) according to Table VII (ASTM G65-Standard Test Method for Measuring Abrasion Using the Dry Sand/Rubber Wheel, Procedure A) and/or an erosion rate of less than 0.03 mm³/g according to ASTM G76—Standard Test Method for Conducting Erosion Tests by Solid Particle Impingement Using Gas Jets.

In another aspect, a method of making a cladded article comprises providing a substrate, providing an intermediate layer over the substrate and positioning at least one hard particle tile having a pore structure over the intermediate layer. Matrix metal or alloy is positioned adjacent to the porous hard particle tile and heated to infiltrate the pore structure of the tile providing a metal matrix composite layer over the intermediate layer. In some embodiments, a plurality of hard particle tiles having a porous structure are positioned over the intermediate layer and infiltrated with matrix metal or alloy rendering the tiles fully dense or substantially fully dense. As described herein, hard particles unassociated with the hard particle tiles can also be incorporated in the metal matrix composite layer such as between hard particles tiles and/or between the intermediate layer and the hard particle tiles.

As described herein, suitable metallic substrates can comprise any metal or alloy substrate of Section I above, including cast iron, low-carbon steels, alloy steels, tool steels, stainless steels, nickel metal, nickel alloys, copper alloys, cobalt metal or cobalt alloys.

The intermediate layer of the cladding, in some embodiments, is a layer of metal or alloy. Suitable metals or alloys for an intermediate layer can be selected according to various considerations including, but not limited to, the compositional identity of the substrate, desired hardness of the intermediate layer, compositional identity of the metal or alloy matrix of the composite layer and/or the desired functionality of the intermediate layer of the cladding. In some embodiments, for example, an intermediate layer can demonstrate crack arrest, stress arrest, bonding enhancement and/or corrosion resistant functionalities.

An alloy of the intermediate layer, in some embodiments, is nickel-based alloy, copper-based alloy or cobalt-based alloy. The intermediate layer can comprise any alloy composition described in Section I suitable for an intermediate layer, including stainless steel or an alloy selected from any of Tables IX-XI.

A metal or alloy intermediate layer, in some embodiments, is fully dense or substantially fully dense. In some embodiments, the fully dense or substantially fully dense metal or alloy of the intermediate layer displays a structure or construction consistent with being deposited by one of weld overlay, plasma transferred arc, thermal spray, cold spray, laser cladding, infrared cladding, induction cladding or other cladding technologies.

Alternatively, in some embodiments, a metal or alloy sheet or foil is positioned over the metallic substrate and subsequently heated to provide an intermediate layer. In such embodiments, the metal or alloy intermediate layer can be fully dense or substantially fully dense. Additionally, in some embodiments, the intermediate layer of metal or alloy is provided by positioning over the substrate a particulate composition comprising powder metal or powder alloy in a carrier. The particulate composition is subsequently heated to provide the metal or alloy intermediate layer. As described herein, a carrier for the powder metal or powder alloy can be a polymeric material or a liquid carrier.

The particulate composition of metal or alloy can be heated under conditions sufficient to provide a fully dense or substantially fully dense intermediate layer. Alternatively, in some embodiments, heating conditions for the particulate composition of powder metal or powder alloy provide an intermediate layer having a pore structure. Porosity of an intermediate layer, in some embodiments, is less than about 40% by volume or less than about 30% by volume. Porosity of the metal or alloy of the intermediate layer can be substantially uniform and/or interconnected. Porosity of a metal or alloy intermediate layer, in some embodiments, is infiltrated by matrix metal or alloy of the overlying composite layer. Infiltration by matrix metal or alloy of the composite layer can render the intermediate layer fully dense or substantially fully dense.

Heating the particulate composition forming the intermediate layer, in some embodiments, is administered prior to heating the matrix metal or alloy forming the composite layer. Alternatively, heating the particulate composition forming the intermediate layer can be administered during heating of the matrix metal or alloy composition forming the composite layer. In some embodiments wherein the intermediate layer has pore structure, the pore structure can be infiltrated with matrix metal or alloy of the composite layer irrespective of whether the particulate composition forming the intermediate layer is heated prior to or concurrent with heating of the matrix metal or alloy.

As provided in Section I herein, an intermediate layer can further comprise particles disposed in the metal or alloy providing metal matrix composite. Particles suitable for use with the metal or alloy of an intermediate layer can comprise hard particles including, but not limited to, particles of metal carbides, metal nitrides, metal borides, metal silicides, ceramics, cemented carbides or cast carbides or mixtures thereof. Hard particles can also comprise precipitates in the matrix metal or alloy.

A metal matrix composite intermediate layer, in some embodiments, is provided by positioning over a surface of the metallic substrate a particulate composition comprising the hard particles in a carrier and infiltrating the particulate composition with the matrix metal or alloy of the composite layer overlying the intermediate layer. The carrier of the particulate composition can comprise a polymeric sheet or liquid carrier described herein.

In some embodiments, a metal matrix composite intermediate layer comprising hard particles is provided by positioning over a surface of the substrate a particulate composition comprising hard particles and powder metal or powder alloy in a carrier and heating the particulate composition to provide the hard particles in matrix metal or alloy formed by melting the powder metal or powder alloy. The carrier of the hard particles and powder metal or powder alloy can be a polymeric material or liquid carrier described herein. Further, in some embodiments, powder metal or powder alloy is provided in a carrier separate from the hard particles. Heating the particulate composition forming the intermediate layer can be administered prior to heating the matrix metal or alloy forming the composite layer. Alternatively, heating the particulate composition forming the intermediate layer can be administered during heating of the matrix metal or alloy forming the composite layer of the cladding

In some embodiments wherein an intermediate layer is provided prior to application of the metal matrix composite layer of the cladding, the intermediate layer can be processed to provide a desired surface roughness. An intermediate layer, in some embodiments, is processed to provide a surface roughness (Ra_{μinches}) less than about 250 Ra. In some embodiments, an intermediate layer is processed to provide a surface roughness less than about 200 Ra or less than about 100 Ra. An intermediate layer, in some embodiments, is processed to provide a surface roughness ranging from about 20 Ra to about 250 Ra or from about 30 Ra to about 125 Ra. An intermediate layer can be processed according to a variety of techniques including mechanical means, such as grinding, sand/grit blasting or combinations thereof.

As described herein, a metal matrix composite layer is provided over the one or more intermediate layers of the cladding. At least one hard particle tile having a pore structure is arranged over the intermediate layer. In some embodiments, a single continuous hard particle tile having a pore structure is arranged over the intermediate layer. In other embodiments, a plurality of porous hard particle tiles are arranged over the intermediate layer. Porous hard particle tiles can further be arranged in a predetermined pattern. Suitable hard particle tiles having a pore structure can have any construction and/or properties described in Section I above. Further, hard particles unassociated with the porous tiles can fill spacing among the tiles and/or spacing between the intermediate layer and the tiles. Matrix metal or alloy is positioned over, under or adjacent to the one or more hard particle tiles and heated to infiltrate the pore structure of the hard particle tile(s) and flow over, under and/or between any unassociated hard particles and fill spacing between the hard particle tiles, unassociated hard particles and intermediate layer providing a fully dense or substantially fully dense composite layer metallurgically bonded to the intermediate layer.

Matrix metal or alloy can comprise any metal or alloy described in Section I herein, including nickel-based alloys, copper-based alloys, cobalt-based alloys or iron-based alloys. Matrix metal or alloy, in some embodiments, is provided as a sheet, foil or slab. In some embodiments, for example, matrix alloy is a sheet or foil having compositional parameters selected from any of Tables III-VI herein. Matrix metal or alloy can also be provided in particulate form as described herein.

Further, a mold may be used for construction of a cladding comprising the metal matrix composite layer over the intermediate layer. As described herein, a mold can surround the metallic substrate surface to be cladded resulting in spacing between the mold and the substrate surface. A mold can be employed after formation of the intermediate layer or prior to formation of the intermediate layer.

The resulting metal matrix composite layer over the intermediate layer can have any properties for a metal matrix composite layer described in Section I herein. For example, in some embodiments, the metal matrix composite layer exhibits an AVL according to Table VII (ASTM G65-Standard Test Method for Measuring Abrasion Using the Dry Sand/Rubber Wheel, Procedure A) and/or an erosion rate less 0.03 mm³/g according to ASTM G76—Standard Test Method for Conducting Erosion Tests by Solid Particle Impingement Using Gas Jets.

These and other non-limiting embodiments are further illustrated by the following non-limiting examples.

### Example 1

The outer diameter of a steel bearing was provided a metal matrix composite cladding as follows.

The steel bearing was four inches in outer diameter and five inches in length and required a cladded region of four inches and a cladding thickness of one-tenth of an inch. Hard particle tiles having pore structure were placed on the inner diameter surface of a mold with glue. Arrangement of hard particle tiles having pore structure on the inner diameter surface of the mold is generally illustrated FIGS. 5-7 herein. The porous hard particle tiles were constructed by partially sintering tungsten carbide (WC) powder to 70% full density. The tiles were arranged in a pattern to maximize the wear properties for the specific application.

Second, the mold was placed surrounding the cleaned and outer diameter surface of the steel bearing, to form a spacing between the inner diameter surface of the mold and outer diameter surface of the steel bearing. Crushed cemented tungsten carbide powder of −325 mesh was then filled and packed into the spacing among the porous carbide tiles, inner diameter surface of the mold and the outer diameter surface of the steel bearing of the mold/bearing assembly. A Ni-based matrix alloy comprising 14-16 wt % chromium and 3.0-4.5 wt. % boron was placed over the crushed cemented WC powder in an amount sufficient to infiltrate fully the crushed cemented WC powder and the pore structure of the WC tiles.

The resulting assembly, including the tiled mold, steel bearing, crushed cemented WC powder in the spacing and Ni-based matrix alloy, was heated in a vacuum furnace until the matrix alloy melted and infiltrated the pore structure of the WC tiles and the packed crushed cemented WC powder providing a fully dense metal matrix composite cladding metallurgically bonded to the steel bearing outer diameter surface. After cooling, the mold was removed and the cladded article was machined to final surface finish and dimensions. The erosion rate of the metal matrix composite cladding was about 0.023 mm³/g according to ASTM G76—Standard Test Method for Conducting Erosion Tests by Solid Particle Impingement Using Gas Jets at 90°. The abrasion rate was about 3.5 mm³ according to ASTM G65-Standard Test Method for Measuring Abrasion Using the Dry Sand/Rubber Wheel, Procedure A.

### Example 2

The outer diameter surface of a steel bearing was provided a metal matrix composite cladding as set forth in Example 1, the sole difference being crushed crystalline tungsten carbide in a variety of mesh sizes replaced the −325 mesh crushed cemented WC used to fill the spacing among the mold, bearing surface and partially sintered WC tiles, The resulting metal matrix composite cladding demonstrated an erosion rate of 0.024 mm³/g according to ASTM G76—Standard Test Method for Conducting Erosion Tests by Solid Particle Impingement Using Gas Jets at 90° and an abrasion rate of 3.8 mm³ according to ASTM G65-Standard Test Method for Measuring Abrasion Using the Dry Sand/Rubber Wheel, Procedure A.

### Example 3

The inner diameter surface of a steel bearing was provided a metal matrix composite cladding as follows. Partially sintered WC tiles of Example 1 were applied to the outer diameter surface of a mold, and the mold was placed within the inner diameter of the steel bearing. As in Example 1, the inner diameter surface of the bearing was cleaned and grit blasted prior to assembly with the mold. Crushed cemented tungsten carbide powder as used in Example 1 was filled and packed into spacing among the WC tiles, outer diameter surface of the mold and inner diameter surface of the steel bearing. Ni-based matrix alloy of Example 1 was placed over the crushed cemented WC powder in an amount sufficient to infiltrate fully the crushed cemented WC powder and the pore structure of the WC tiles. The resulting assembly was heated until the Ni-based matrix alloy melted and infiltrated the pore structure of the WC tiles and the packed crushed cemented WC powder providing a fully dense metal matrix composite cladding metallurgically bonded to the inner diameter surface of the steel bearing. The resulting metal matrix composite cladding demonstrated an erosion rate of 0.023 mm³/g according to ASTM G76—Standard Test Method for Conducting Erosion Tests by Solid Particle Impingement Using Gas Jets at 90° and an abrasion rate of 3.5 mm³ according to ASTM G65-Standard Test Method for Measuring Abrasion Using the Dry Sand/Rubber Wheel, Procedure A.

### Example 4

The outer diameter surface of a steel bearing was provided a metal matrix composite cladding as set forth in Example 1, the sole difference being the partially sintered WC tiles having pore structure were arranged on the outer diameter surface of the steel bearing as opposed to the inner diameter surface of the surrounding mold. The resulting metal matrix composite cladding demonstrated an erosion rate of 0.024 mm³/g according to ASTM G76—Standard Test Method for Conducting Erosion Tests by Solid Particle Impingement Using Gas Jets at 90° and an abrasion rate of 3.8 mm³ according to ASTM G65-Standard Test Method for Measuring Abrasion Using the Dry Sand/Rubber Wheel, Procedure A.

### Example 5

The outer diameter surface of a steel bearing was provided a metal matrix composite cladding as set forth in Example 1, the differences being a Cu-based matrix alloy comprising 19-26 wt. % nickel and 19-26 wt. % manganese was used and the assembly of the tiled mold, steel bearing, crushed cemented WC powder and Cu-based matrix alloy was heated under nitrogen atmosphere to provide the metal matrix composite cladding having porous WC tiles infiltrated with Cu-based matrix alloy.

Various embodiments of the invention have been described in fulfillment of the various objects of the invention. It should be recognized that these embodiments are merely illustrative of the principles of the present invention. Numerous modifications and adaptations thereof will be readily apparent to those skilled in the art without departing from the spirit and scope of the invention.

That which is claimed is:

1. An article comprising:
a metallic substrate; and
a cladding adhered to the metallic substrate, the cladding including a metal matrix composite layer comprising at least one hard particle tile having a pore structure infiltrated with matrix metal or matrix alloy.

2. The article of claim 1, wherein the hard particle tile infiltrated with the matrix metal or matrix alloy is substantially fully dense.

3. The article of claim 1, wherein the hard particle tile comprises one or more carbides, nitrides, borides, silicides, cemented carbides, carbonitrides, cast carbides, intermetallic compounds or mixtures thereof.

4. The article of claim 1, wherein the hard particle tile has porosity less than 50% by volume, the porosity infiltrated with the matrix metal or matrix alloy.

5. The article of claim 1, wherein the hard particle tile has porosity less than 40% by volume, the porosity infiltrated with the matrix metal or matrix alloy.

6. The article of claim 1, wherein the matrix alloy is nickel-based alloy, cobalt-based alloy, copper-based alloy or iron-based alloy.

7. The article of claim 1, wherein the cladding is metallurgically bonded to the substrate.

8. The article of claim 1, wherein the metal matrix composite layer demonstrates an erosion rate less than 0.03 mm³/g at a particle impingement angle of 90° according to ASTM G76-07.

9. The article of claim 1, wherein the metal matrix composite layer demonstrates an erosion rate less than 0.02 mm³/g at a particle impingement angle of 90° according to ASTM G76-07.

10. The article of claim 1, wherein the metal matrix composite layer demonstrates an average volume loss less than 12.0 mm³ according to ASTM G65 Standard Test Method for Measuring Abrasion Using the Dry Sand/Rubber Wheel, Procedure A.

11. The article of claim 1, wherein the metal matrix composite layer demonstrates an average volume loss less than 8 mm³ according to ASTM G65 Standard Test Method for Measuring Abrasion Using the Dry Sand/Rubber Wheel, Procedure A.

12. The article of claim 1, wherein the metal matrix composite layer demonstrates an average volume loss less than 5 mm³ according to ASTM G65 Standard Test Method for Measuring Abrasion Using the Dry Sand/Rubber Wheel, Procedure A.

13. The article of claim 1, wherein the metal matrix composite layer further comprises hard particles unassociated with the at least one hard particle tile.

14. The article of claim 1, wherein the metal matrix composite layer comprises a plurality of hard particle tiles having pore structures infiltrated with matrix metal or matrix alloy.

15. The article of claim 14, wherein the hard particle tiles infiltrated with the matrix metal or matrix alloy are substantially fully dense.

16. The article of claim 14, wherein the hard particle tiles are arranged in a predetermined pattern.

17. The article of claim 14, wherein the metal matrix composite layer further comprises hard particles in spacing between the hard particle tiles and metallic substrate surface.

18. The article of claim 1, wherein the hard particle tile has a shape complimentary to the metallic substrate.

19. The article of claim 1 further comprising one or more intermediate layers between the metallic substrate and the metal matrix composite layer, the intermediate layer being a metal or alloy or a metal matrix composite.

20. The article of claim 19, wherein the intermediate layer is substantially fully dense.

21. The article of claim 1, wherein the metal matrix composite layer has a hard particle content of greater than 50 percent by volume.

22. The article of claim 1, wherein the metal matrix composite layer has a hard particle content of greater than 60 percent by volume.

23. The article of claim 1, wherein the pore structure of the hard particle tile is an interconnected pore structure.

24. A method of making a cladded article comprising:
providing a metallic substrate;
positioning at least one hard particle tile having a pore structure over a surface of the metallic substrate;
positioning matrix metal or alloy over or adjacent to the porous hard particle tile; and
heating the matrix metal or alloy to infiltrate the pore structure of the hard particle tile providing a metal matrix composite cladding adhered to the substrate.

25. The method of claim 24, wherein the hard particle tile and metal matrix composite cladding are substantially fully dense.

26. The method of claim 24, wherein the hard particle tile has porosity 5% to 50% by volume prior to infiltration of the pore structure by the matrix metal or alloy.

27. The method of claim 24, wherein the composite cladding is metallurgically bonded to the substrate.

28. The method of claim 24, wherein the hard particle tile is affixed to the surface of a mold surrounding the surface of the metallic substrate to be cladded.

29. The method of claim 28 further comprising filling spacing between the mold, hard particle tile and metallic substrate surface with hard particles.

30. The method of claim 29, wherein the matrix metal or alloy is positioned to infiltrate the pore structure of the hard particle tile and spacing between the mold, hard particles, hard particle tile and metallic substrate when heated.

31. The method of claim 24, wherein a mold surrounds the surface of the metallic substrate to be cladded and the hard particle tile is affixed to the metallic substrate surface.

32. The method of claim 31 further comprising filling spacing between the mold, hard particle tile and metallic substrate surface with hard particles.

33. The method of claim 32, wherein the matrix metal or alloy is positioned to infiltrate the pore structure of the hard particle tile and spacing between the mold, hard particle tile, hard particles and metallic substrate surface.

34. The method of claim 24, wherein a mold surrounds the surface of the metallic substrate to be cladded and the at least one hard particle tile and hard particles unassociated with the tile are filled in spacing between the metallic substrate surface and mold.
